(19) United States
(12) Patent Application Publication
(10) Pub. No.: US 2018/0012157 A1
(43) Pub. Date: Jan. 11, 2018

(54) CONSUMPTION ESTIMATION SYSTEM AND METHOD THEREOF

(71) Applicants: Panayotis KIKIRAS, Darmstadt (DE); Holger ZIEKOW, Frankfurt (DE)

(72) Inventors: Panayotis KIKIRAS, Darmstadt (DE); Holger ZIEKOW, Frankfurt (DE)

(21) Appl. No.: 15/203,021

(22) Filed: Jul. 6, 2016

(51) Int. Cl. G06Q 10/06

(52) U.S. Cl. CPC G06Q 10/0631

(57) ABSTRACT

A method of, and system for, estimating a consumption value of a consumption device from a set of consumption devices (CDs). The method includes storing in a memory of a computer a model indicative of dependency between consumption relationships of CDs from the set of CDs, and transforming the operational measured value into estimated consumption values of one or more CDs, wherein transforming is provided by a processor operatively connected to the memory using the model stored in the memory.

### TECHNICAL FIELD

The presently disclosed subject matter relates to systems and methods of estimating an amount of product consumed by a device, and, in particular, to systems and methods of consumption disaggregating.

### BACKGROUND

There exist many devices that are designed for consuming a given product, hereinafter termed consumption devices (CDs). For example, the consumed products can be utilities such as gas, water or electricity. As such, the CDs can be appliances or other amenities. Typical electricity consuming appliances include washers, dryers, computers, televisions, refrigerators, lamps, air conditioners, ovens, etc. Typical other amenities include showers, faucets, toilets, boilers, stove tops, etc.

A given set of CDs is typically associated with meters that are able to keep track of and measure the total aggregated amount of product consumed by all of the plurality of CDs in the set of CDs taken together. For example, a total amount of electricity used by all of the electrical devices in a particular household, factory or other building or group of buildings, within a particular area, etc. However, these meters may be unable to provide device specific consumption values of how much product was consumed by each individual CD on its own.

Consumption disaggregation involves taking an aggregated consumption value of a set of CDs (for example, the total power consumption of a house as read by an electricity meter), and separating the aggregated value into individual values for at least part of the CDs in the set. Energy disaggregation is also known as non-intrusive load monitoring (NILM).

Problems of consumption disaggregation have been recognized in the conventional art and various techniques have been developed to provide solutions, for example:

US Patent Publication number 2013/0231795 describes a method and system for a composite load disaggregation. The system comprises an input module, a factor graph module, a contextual information database, a rule engine, a priori database and a rule database. The factor-graph module is configured to perform factor-graph analysis on one or more input variables received from the input module to generate confidence measures wherein the confidence measures indicate the composite load disaggregation.

PCT Publication number WO2014090969 describes a system for load disaggregation. An electrical power data processing system has an interface to an electricity power sensor and a processor adapted to perform pre-processing of the sensor data to provide data for load disaggregation. The processor detects data failure and disables load disaggregation on data loss, incomplete data sets, corrupt data, inconsistent data, and unsynchronised data. Also, it automatically detects data loss for a parameter by detecting lack of time synchronisation between parameters of a given electrical reading in response to an event. The event may be a power event having a concurrent variation of a number of electrical parameters. The processor determines if a current sensor data periodicity pattern falls outside periodicity rules.

U.S. Pat. No. 8,983,670 describes a system for disaggregating a gross energy measurement into individual component energy consumption. A collection of components may be situated in a facility. A sensor may obtain electrical signals from one or more power input lines which convey power to the facility for the components. The signals may indicate the total energy consumption by the collection of components. Approaches and/or mechanisms may be used to disaggregate the indication of total energy consumption into indications of individual energy consumption by the components without the need for separately determining the individual energy consumption with additional measurements or instrumentation.

US Patent Publication number 2014/0207298 describes a method for remotely setting, controlling, or modifying settings on a programmable communicating thermostat (PCT) in order to customize settings to a specific house and user, including steps of: receiving at a remote processor information entered into the PCT by the user; receiving at the remote processor: non-electrical information associated with the specific house or user; and energy usage data of the specific house; performing by the remote processor energy disaggregation on the energy usage data; determining by the remote processor a custom schedule for the PCT based upon the information entered by the user, the non-electrical information associated with the specific house or user, and disaggregated energy usage data; revising by the remote processor, the custom schedule for the PCT based upon additional user input or seasonal changes; providing the custom schedule for the PCT to the PCT.

US Patent Publication number 2015/0142695 describes systems and methods for performing energy disaggregation of a whole-house energy usage waveform, based at least in part on the whole-house energy usage profile, training data, and predetermined generic models, including: a module for pairing impulses identified in the whole-house energy usage waveform to indicate an appliance cycle, pairing impulses with at least one up transition with at least one down transition; a module for bundling impulses that are representative of an appliance cycle; a classification module, which upon determination of a type of appliance associated with bundles, is configured to classify the bundles of transitions in accordance with bundles exhibited by similar appliances with similar characteristics; and utilizing such pairing module and module for bundling to perform energy disaggregation. Moreover, the Publication describes graphical user interfaces for the presentation of such data and the receipt of user-supplied validation and information.

Indian Patent Publication number IN00311CH2014 describes a Non Intrusive Load Monitoring (NILM) system and method for an electrical network for disaggregating load from plurality of electrical energy sources. The system comprises a switch to indicate an active state of an electrical energy source from a plurality of electrical energy sources, a means to monitor and measure electrical parameters of a load consumption signal drawn by one or more energy consuming devices, a means to process the load consumption signal for disaggregation based on the active electrical energy source, and a means to disaggregate the load consumption signal to the one or more energy consuming devices.

“Kolter, J. Zico, Siddharth Batra, and Andrew Y. Ng. “Energy disaggregation via discriminative sparse coding.” Advances in Neural Information Processing Systems. 2010” discloses energy disaggregation via a Discriminative Disaggregation Sparse Coding (DDSC) algorithm.

The references cited above teach background information that may be applicable to the presently disclosed subject matter. Therefore the full contents of these publications are incorporated by reference herein where appropriate for appropriate teachings of additional or alternative details, features and/or technical background.

### GENERAL DESCRIPTION

According to one aspect of the presently disclosed subject matter there is provided a computerized method of estimating a consumption value of a consumption device from a set of consumption devices (CDs). The method includes storing in a memory of a computer a model indicative of dependency between consumption relationships of CDs from the set of CDs. The model is obtained by processing a plurality of intermediate models. Each intermediate model is obtained for a subset of at least one CD and is indicative of dependency of a consumption relationship between CDs from the respective subset and a value of aggregated consumption of all CDs from the set of CDs. An intermediate model of a given subset is obtained by processing results of CD-aware consumption measurements having been taken from the given subset and substantially simultaneous measurements of intermediate aggregated consumption of all CDs from the set of CDs. CD-aware consumption measurements are provided for each given CD from the given subset of CDs, using at least one consumption sensor associated with the given CD during CD-aware consumption measurement. Subsets of CDs used in any two intermediate models from the plurality of intermediate models include at least one common CD. The method further includes measuring an operational aggregated consumption of the set of CDs, the operational aggregated consumption being measured using an aggregate sensor operatively connected to each CD from the set of CDs, and storing the results in the memory to yield an operational measured value of the operational aggregated consumption of all CDs from the set of CDs; and transforming the operational measured value into estimated consumption values of one or more CDs. Transforming is provided by a processor operatively connected to the memory using the model stored in the memory.

In addition to the above features, the method according to this aspect of the presently disclosed subject matter can include one or more of features (i) to (vi) listed below, in any desired combination or permutation which is technically possible:
(i). after storing and substantially simultaneous to measuring an operational aggregated consumption: measuring an operational CD consumption of at least one CD, the operational CD consumption being measured using at least one consumption sensor associated with the given CD from the set of CDs, and storing the results in the memory to yield an operational measured value of the operational CD consumption of the given CD that overlaps at least partially with the operational measured value of the operational aggregated consumption of all CDs from the set of CDs; and wherein transforming the operational measured value into estimated consumption values of one or more CDs is provided by a processor operatively connected to the memory and also using the operational measured value of the operational CD consumption of the given CD stored in the memory.
(ii). wherein the intermediate model of a given subset of at least one CD is obtained by also processing results of context measurements having been taken from the environment of at least one CD and substantially simultaneous to the intermediate measurements of aggregated consumption of all CDs from the set of CDs, wherein the context measurements having been provided using at least one context sensor related to the at least one CD.
(iii). wherein the CD-aware context measurements are indicative of at least one environmental parameter related to the at least one CD, the context measurements having been taken from the at least one context sensor disposed in the physical environment of the at least one CD.
(iv). after storing and substantially simultaneous to measuring an operational aggregated consumption: measuring an operational context measurement related to at least one CD, the operational context measurement being measured using at least one context sensor related to the given CD from the set of CDs, and storing the results in the memory to yield an operational measured value of the operational context measurements related to the given CD that overlaps at least partially with the operational measured value of the operational aggregated consumption of all CDs from the set of CDs; and wherein transforming the operational measured value into estimated consumption values of one or more CDs is provided by a processor operatively connected to the memory and also using the operational measured value of the operational context measurements of the given CD stored in the memory.
(v). wherein the set of CDs includes at least one unknown CD that is not included in any of the subsets, and transforming includes transforming the operational measured value into estimated consumption values of one or more unknown CDs, wherein transforming is provided by a processor operatively connected to the memory using the model stored in the memory.
(vi). wherein the model is obtained by processing a plurality of intermediate models, wherein each intermediate model is obtained by processing results of intermediate measurements of an aggregated consumption of all CDs from the set of CDs, and wherein the set of CDs includes at least one unknown CD that is not included in any of the subsets.

According to another aspect of the presently disclosed subject matter there is provided a consumption estimation block configured to estimate a consumption value of a consumption device from a set of consumption devices (CDs). The consumption estimation block includes a processor and a memory and is operatively connectable to an aggregate sensor operatively connected to each CD from the set of CDs. The memory is configured to store a model indicative of dependency between consumption relationships of CDs from the set of CDs. The model is obtained by processing a plurality of intermediate models. Each intermediate model is obtained for a subset of at least one CD and is indicative of dependency of a consumption relationship between CDs from the respective subset and a value of aggregated consumption of all CDs from the set of CDs. An intermediate model of a given subset is obtained by processing results of CD-aware consumption measurements having been taken from the given subset and substantially simultaneous measurements of intermediate aggregated consumption of all CDs from the set of CDs. The CD-aware consumption measurements are provided, for each given CD from the given subset of CDs, using at least one consumption sensor associated with the given CD during CD-aware consumption measurement. Subsets of CDs used in any two intermediate models from the plurality of intermediate models include at least one common CD. The memory is further configured to store an operational measured value of the operational aggregated consumption of all CDs from the set of CDs. The operational measured value is yielded from an operational aggregated consumption of the set of CDs. The operational aggregated consumption is provided using the aggregate sensor. The processor is operatively connected to the memory and configured to transform the operational measured value into estimated consumption values of one or more CDs.

This aspect of the disclosed subject matter can optionally include one or more of features (i) to (vi) listed above, mutatis mutandis, in any desired combination or permutation which is technically possible.

According to another aspect of the presently disclosed subject matter there is provided a computerized method of generating a model usable for estimating a consumption value of a consumption device from a set of consumption devices (CDs). The method includes, upon obtaining a plurality of intermediate models indicative of consumption relationship between a subset of CDs, wherein an intermediate model of a given subset of at least one CD is obtained by processing results of CD-aware consumption measurements having been taken from the given subset and substantially simultaneous measurements of intermediate aggregated consumption of all CDs from the set of CDs, wherein the CD-aware consumption measurements are provided, for each given CD from the given subset of CDs, using at least one consumption sensor associated with the given CD, each intermediate model including at least one CD-aware consumption measurement provided by a CD that is included in at least one other subset: processing the plurality of intermediate models to obtain a model indicative of dependency between consumption relationships of CDs from the set of CDs and storing the model in a memory of a computer, wherein the model is usable for transforming an operational measured value of the operational aggregated consumption of all CDs from the set of CDs into estimated consumption values of one or more CDs. Transforming is provided by a processor operatively connected to the memory using the model stored in the memory upon obtaining an operational aggregated consumption of the set of CDs, the operational aggregated consumption being measured using an aggregate sensor operatively connected to each CD from the set of CDs. Storing the results in the memory yields an operational measured value.

This aspect of the disclosed subject matter can optionally include one or more of features (i) to (vi) listed above, mutatis mutandis, in any desired combination or permutation which is technically possible.

According to another aspect of the presently disclosed subject matter there is provided a system capable of estimating a consumption value of a consumption device from a set of consumption devices (CDs), the system including: an aggregate sensor, the aggregate sensor being operatively connected to each CD from the set of CDs; a consumption estimation block having a processor and a memory, the consumption estimation block being operatively connected to the aggregate sensor. The memory is configured to store a model which is indicative of dependency between consumption relationships of CDs from the set of CDs. The model is obtained by processing a plurality of intermediate models. Each intermediate model is obtained for a subset of at least one CD and is indicative of dependency of a consumption relationship between CDs from the respective subset and a value of aggregated consumption of all CDs from the set of CDs. An intermediate model of a given subset is obtained by processing results of CD-aware consumption measurements having been taken from the given subset and substantially simultaneous measurements of intermediate aggregated consumption of all CDs from the set of CDs. CD-aware consumption measurements are provided for each given CD from the given subset of CDs, using at least one consumption sensor associated with the given CD during CD-aware consumption measurement. Subsets of CDs used in any two intermediate models from the plurality of intermediate models include at least one common CD. The aggregate sensor is configured to measure an operational aggregated consumption of the set of CDs. Results are stored in the memory to yield an operational measured value of the operational aggregated consumption of all CDs from the set of CDs. The processor is operatively connected to the memory and is configured to transform the operational measured value into estimated consumption values of one or more CDs.

This aspect of the disclosed subject matter can optionally include one or more of features (i) to (vi) listed above, mutatis mutandis, in any desired combination or permutation which is technically possible.

According to another aspect of the presently disclosed subject matter there is provided a non-transitory program storage device readable by machine, tangibly embodying a program of instructions executable by the machine to perform a method of estimating a consumption value of a consumption device from a set of consumption devices (CDs). The method includes storing in a memory of a computer a model indicative of dependency between consumption relationships of CDs from the set of CDs. The model is obtained by processing a plurality of intermediate models. Each intermediate model is obtained for a subset of at least one CD and is indicative of dependency of a consumption relationship between CDs from the respective subset and a value of aggregated consumption of all CDs from the set of CDs. An intermediate model of a given subset is obtained by processing results of CD-aware consumption measurements having been taken from the given subset and substantially simultaneous measurements of intermediate aggregated consumption of all CDs from the set of CDs. CD-aware consumption measurements are provided for each given CD from the given subset of CDs, using at least one consumption sensor associated with the given CD during CD-aware consumption measurement. Subsets of CDs used in any two intermediate models from the plurality of intermediate models include at least one common CD. The method further includes measuring an operational aggregated consumption of the set of CDs, the operational aggregated consumption being measured using an aggregate sensor operatively connected to each CD from the set of CDs, and storing the results in the memory to yield an operational measured value of the operational aggregated consumption of all CDs from the set of CDs; and transforming the operational measured value into estimated consumption values of one or more CDs. Transforming is provided by a processor operatively connected to the memory using the model stored in the memory.

This aspect of the disclosed subject matter can optionally include one or more of features (i) to (vi) listed above, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a functional block diagram of a consumption estimation system, in accordance with certain examples of the presently disclosed subject matter;

FIG. 2 illustrates a generalized flow chart of training the consumption estimation system, in accordance with certain examples of the presently disclosed subject matter;

FIGS. 3A-3C illustrate configuration of the consumption estimation system of FIG. 1 during various stages of training, in accordance with certain examples of the presently disclosed subject matter;

FIG. 4 illustrates a generalized flow chart of operating the consumption estimation system, in accordance with certain examples of the presently disclosed subject matter;

FIG. 5 illustrates a configuration of the consumption estimation system during operational phase, in accordance with certain examples of the presently disclosed subject matter; and

FIGS. 6-8 illustrate functional block diagrams of prior art solutions.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “representing”, “generating”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities (including, by way of non-limiting example, consumption estimation block 109 disclosed in the present application).

The terms “non-transitory memory” and “non-transitory storage medium” as used herein should be expansively construed to cover any volatile or non-volatile computer memory suitable to the presently disclosed subject matter.

It is to be understood that the term “signal” used herein excludes transitory propagating signals, but includes any other signal suitable to the presently disclosed subject matter.

The operations in accordance with the teachings herein may be performed by a computer specially constructed for the desired purposes or by a general-purpose computer specially configured for the desired purpose by a computer program stored in a non-transitory computer readable storage medium.

The term “product” used in this patent specification should be expansively construed to cover any kind of appropriate consumable resource or commodity (e.g. electricity/power, water, gas, Internet, etc.) with consumption measurable in accordance with certain examples of the presently disclosed subject matter.

Examples of the presently disclosed subject matter are not described with reference to any particular programming language. It will be appreciated that a variety of programming languages may be used to implement the teachings of the presently disclosed subject matter as described herein.

The term “set of CDs” used herein is defined as a plurality of CDs each one contributing in aggregated consumption when measured. CDs can be included in the set of CDs based on any appropriate considerations, for example, geographic location and/or function (e.g. some or all of the electrical appliances in a household), etc.

It is desirable to know how much product was consumed by each individual CD on its own. By way of non-limiting example, this knowledge can help a user of the set of CDs monitor and control the specific usage of the product, and, thereby allow the user to better manage the set of CDs, and potentially identify problematic CDs.

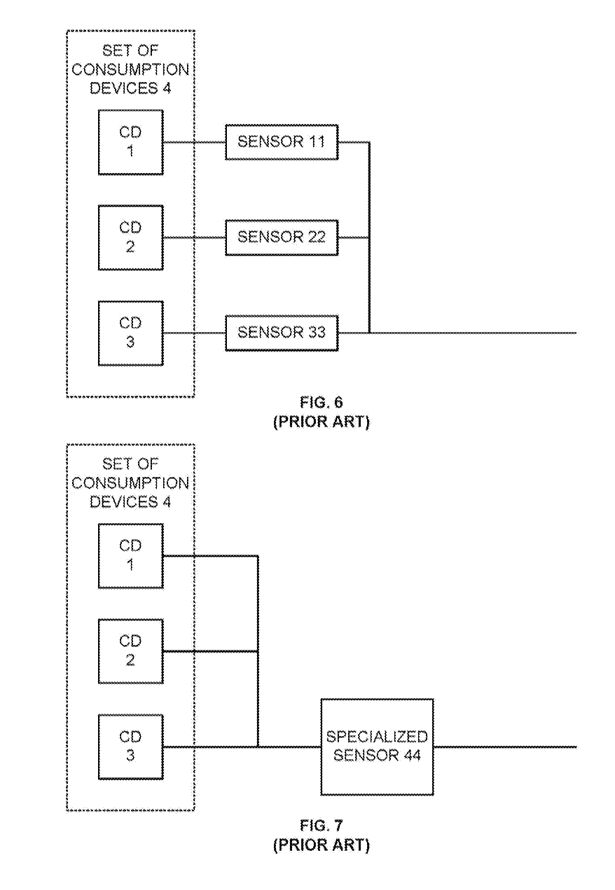

Attention is now drawn to FIGS. 6-8, illustrating functional block diagrams of non-limiting examples of prior art solutions for obtaining device specific consumption values.

A non-limiting example in FIG. 6 illustrates an approach of CD-aware measuring of the operational consumption values of each CD 1, 2, 3, in the set of CDs 4, individually. This approach requires associating each CD in the set of CDs 4 with an individual consumption sensor (denoted, respectively, as 11, 22, 33). This can require a relatively large amount of consumption sensors depending on the number of CDs within the set of CDs 4.

Another approach for obtaining device specific consumption values is measuring the disaggregated, device specific consumption values from an aggregated measurement.

By way of non-limiting example illustrated in FIG. 7, disaggregating an aggregated measurement (i.e. separating a result of aggregated measurement into its components) is done by using a specialized sensor 44. The specialized sensor 44 is disposed at an aggregate sensing point and obtains CD-aware values of the individual consumption from a signal informative of aggregated consumption values.

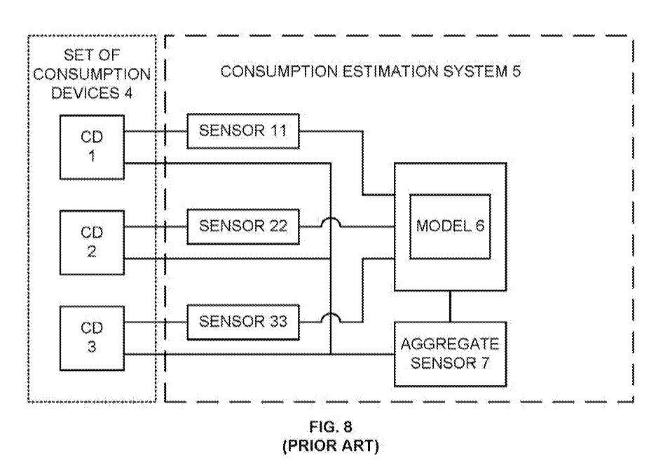

By way of another non-limiting example illustrated in FIG. 8, obtaining device specific consumption values can include estimating the disaggregated, device specific consumption values using a consumption estimation system 5. Known in the prior art consumption estimation systems 5 include a device specific consumption model 6 that is generated using simultaneous individual measurements of all of the CDs 1, 2, 3 in set of CDs 4 in a training phase. Thus, consumption estimation system 5 requires individual consumption sensors 11, 22, 33, to be simultaneously used on each and every one of the CDs 1, 2, 3, during the training phase. The device specific consumption model 6 is used to find likely device specific summands that add up to the aggregated consumption value (i.e. the total value is the sum of all individual values). Depending on the number of CDs within the set of CDs 4, consumption estimation system 5 can require a relatively large amount of consumption sensors, and present an operationally challenging hardware setup.

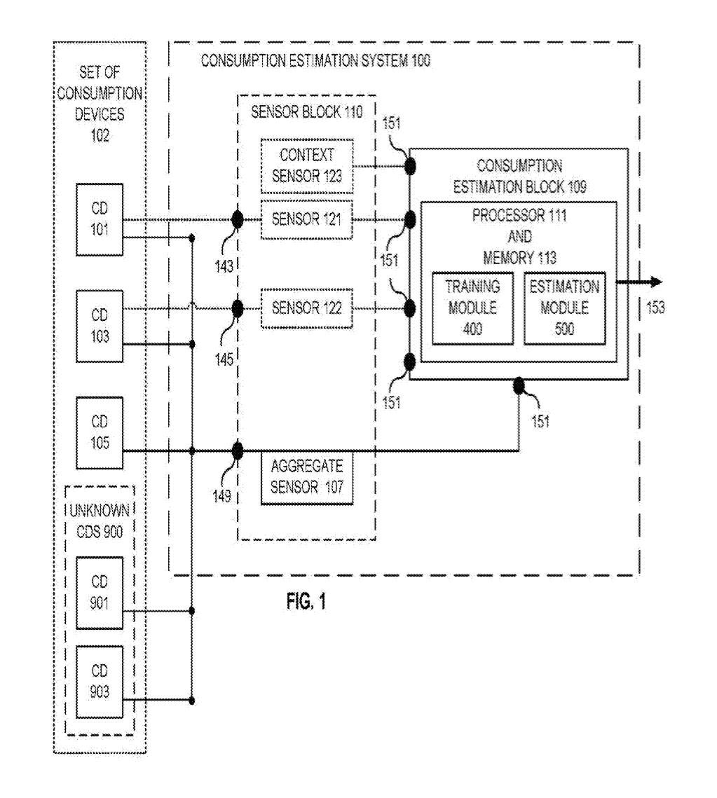

Bearing this in mind, attention is drawn to FIG. 1 illustrating a functional block diagram of a consumption estimation system 100, in accordance with certain examples of the presently disclosed subject matter. The lines connecting elements represent operative connections. As will be further detailed hereinafter, operative connection between CDs and some elements of consumption estimation system are not necessarily permanent and can be temporarily established as appropriate in accordance with certain examples of the presently disclosed subject matter. Temporarily connectable elements are referred to hereinafter also as associated elements.

Consumption estimation system 100 is operatively connected to a set of CDs 102. The set of CDs 102 includes a plurality of consumption devices (CDs) (denoted as 101, 103, 105) configured to consume a product. Optionally, the set of CDs 102 can further include unknown CDs 900. Unknown CDs 900 can include multiple CDs 901, 903. Unknown CDs 900 can include CDs that are actually unknown and/or unavailable for CD-aware consumption measurements and/or excluded from CD-aware consumption measurements because of other reasons. However, unknown CDs 900 contribute to the aggregated consumption.

Consumption estimation system 100 includes two or more consumption sensors (referred to also as sensors) configured to provide consumption measurements associated with the set of CDs 102. For purpose of illustration only, the following description is provided for sensors combined into a sensor block 110. Those skilled in the art will readily appreciate that the teachings of the presently disclosed subject matter are, likewise, applicable to sensors individually connectable to CDs and consumption estimation block 109.

Sensor block 110 can also include one or more input interfaces (e.g. ports of respective sensors, specially designed port(s) operatively connected to the sensors, etc.) denoted as 143, 145, 149. CDs in set of CDs 102 can be operatively connected to sensor block 110 via appropriate input interfaces 143, 145, 149.

Sensor block 110 includes an aggregate sensor 107 configured to provide an aggregated measurement of the total aggregate consumption value of the set of CDs (i.e. consumption of all of the CDs 101, 103, 105, 901 and 903 together). As such, aggregate sensor 107 is configured to be operatively connected to each CD 101, 103, 105 as well as unknown CDs 900 (e.g. via input interface 149).

Sensor block 110 also includes consumption sensors (denoted as 121, 122), each configured to provide a CD-aware consumption value. The number of consumption sensors in sensor block 110 can be substantially less than the number of CDs in the set of CDs 102. Each consumption sensor 121, 122 can be associated with at least one known CD 101, 103, 105. The arrangement of the sensors within the system (i.e. operative connections between the sensors of sensor block 110 and the known CDs of set of CDs 102) can be changed for the different stages of the training phase and operational phase. As such, CDs associated with consumption sensor 121, 122 can vary for different stages of the training phase as well as for the operational phase, as described below.

Optionally, consumption estimation system 100 can further include at least one context sensor 123 configured to provide context measurements. Context sensor 123 relates to a context that is shared between context sensor 123 and at least one CD. Context sensor 123 can be related to one or more of the CDs 101, 103, 105, 901 and 903, and can provide context data informative of the environment of the respective CD(s). By way of non-limiting example, the context data can be informative of motion, time, temperature, brightness, etc. By way of another non-limiting example, context data can be indicative of the presence, e.g. in the vicinity of a CD, of one or more person or other object potentially having an impact on the CD's consumption.

Consumption estimation system 100 includes a consumption estimation block 109 configured to estimate individual consumption values using a measured aggregate value and, optionally, measured CD-aware consumption values. Consumption estimation block 109 can include one or more input interfaces 151, and can be operatively connected to sensor block 110 via input interfaces 151. Consumption estimation block 109 is connected to sensor block 110 to obtain measurements from the various sensors of consumption estimation system 100, for example: aggregate sensor 107, consumption sensors 121, 122, and optionally context sensor 123.

Consumption estimation block 109 also includes a processor 111 and memory 113. Processor 111 is configured to generate, during the training phase, one or more intermediate models. The intermediate models can be stored in memory 113. Each intermediate model is generated from measurements taken from a different subset of CDs and is referred to hereinafter as associated with a subset used for generating the respective intermediate model.

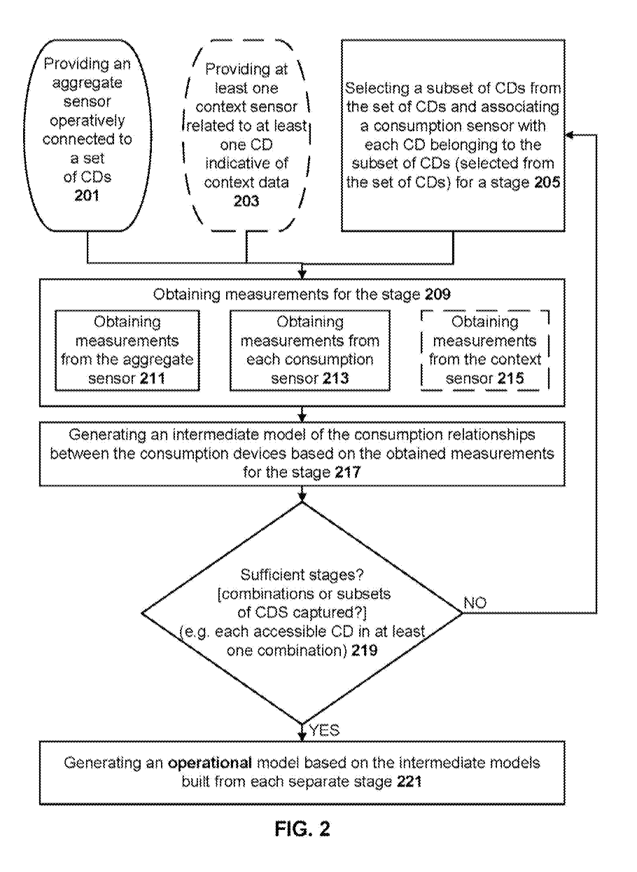

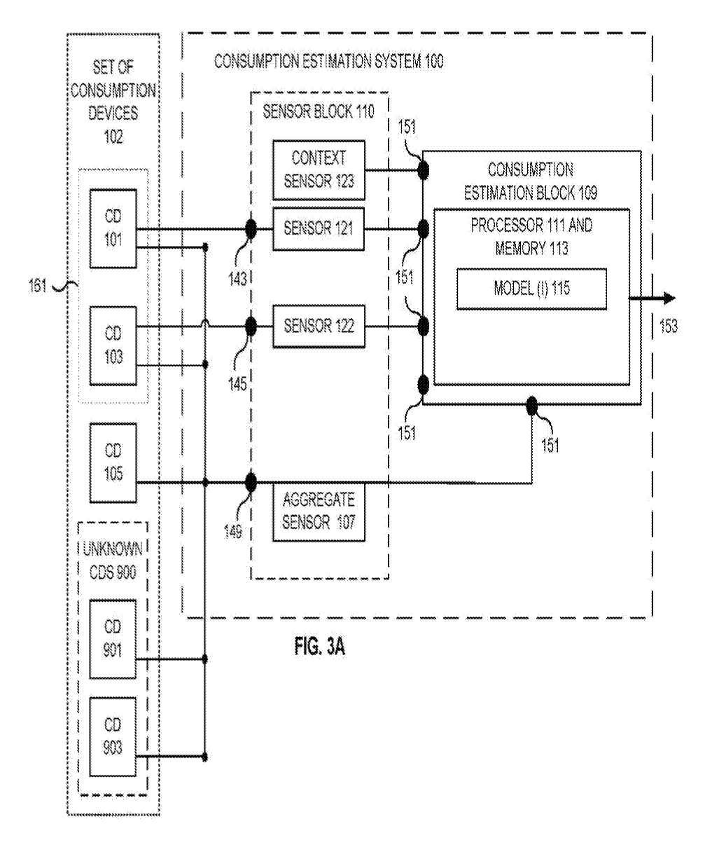

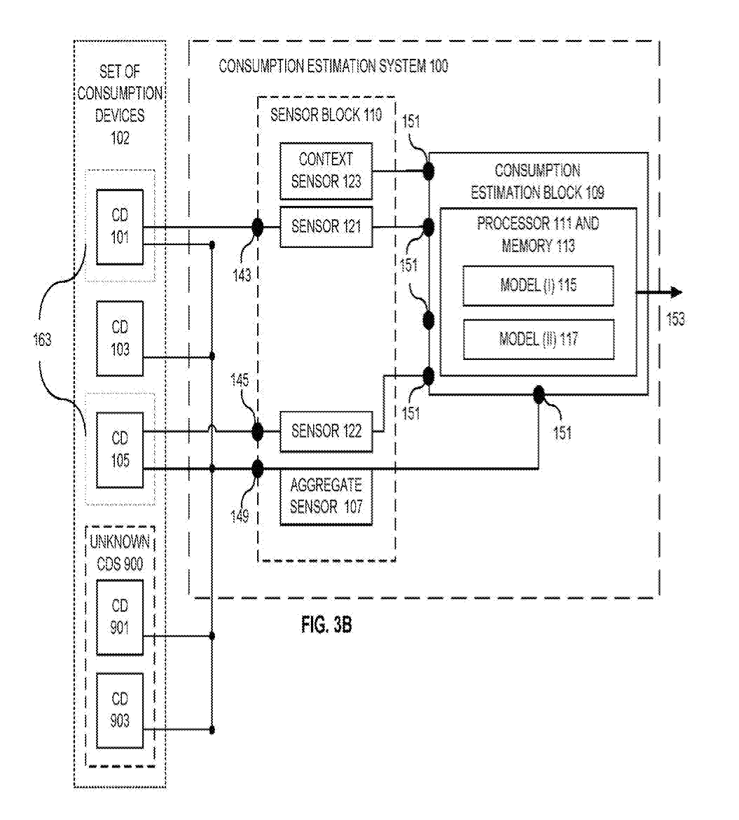

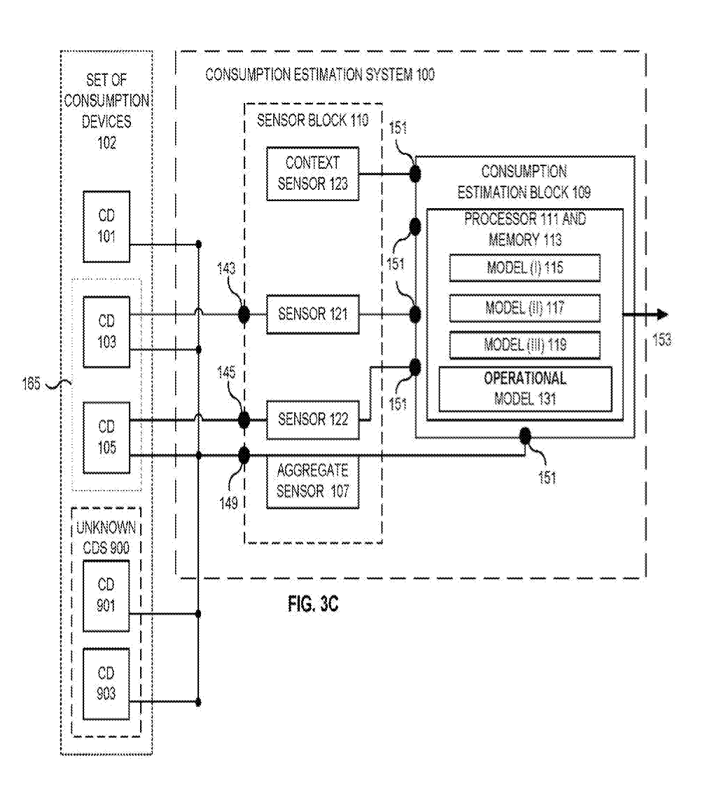

As will be further detailed with reference to FIGS. 2 and 3A-3C, each intermediate model is obtained by processing the results of CD-aware consumption measurements taken from the given subset of CDs and substantially simultaneous intermediate measurements of aggregated consumption of all CDs in the set of CDs. The CD-aware consumption measurements are provided, for each given CD from the given subset of CDs, using at least one consumption sensor associated with the given CD (e.g. a sensor temporarily operatively connected to the given CD). Typically, one consumption sensor will be associated with a given CD. However, optionally, multiple consumption sensors can be associated with a given CD. For example, a plurality of consumption sensors can be associated with a given CD in a case where each sensor measures different parameters. These parameters, when processed together, are indicative of consumption. Alternatively, multiple consumption sensors that all measure the same parameters can be associated with a given CD. Using multiple consumption sensors simultaneously to observe a given CD can be done to help average out measurement error.

The intermediate models generated during the training phase are processed by processor 111 to generate an operational model that is stored in memory 113. The operational model is indicative of the dependencies between consumption relationships of each CD in the set of CDs and aggregated consumption of the set of CDs.

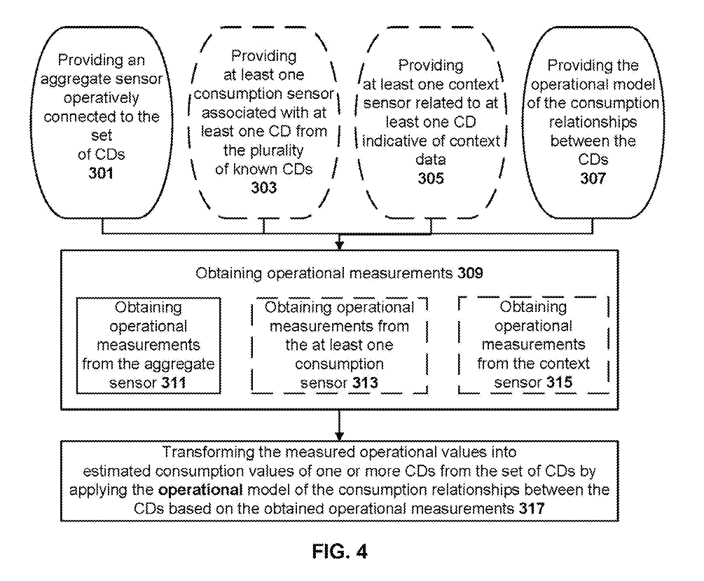

Processor 111 can be configured to execute several functional modules in accordance with computer-readable instructions implemented on a non-transitory computer-readable storage medium. Such functional modules are referred to hereinafter as comprised in processor 111. Processor 111 can comprise a training module 400 and an estimation module 500. Training module 400 can be configured to perform the operations of the training phase, detailed with reference to FIG. 2, to obtain intermediate models and operational model 131. Estimation module 500 can be configured to transform the measured operational aggregate consumption values into individual CD specific consumption values as further detailed with reference to FIG. 4.

Consumption estimation block 109 can also include one or more output interfaces (e.g. specially designed port(s) operatively connectable to other devices, the Internet, etc.) denoted as 153. Data, such as results or measurements, can be output via output interface 153.

It is noted that the teachings of the presently disclosed subject matter are not bound by the consumption estimation system 100 described with reference to FIG. 1. Equivalent and/or modified functionality can be consolidated or divided in another manner and can be implemented in any appropriate combination of software with firmware and/or hardware and executed on a suitable device(s). The consumption estimation system can be a standalone network entity, or integrated, fully or partly, with other network entities. In some examples consumption estimation block 109 can be integrated as part of aggregate sensor 107. In other examples consumption estimation block 109 (or one or more of its modules) can be located at a remote location from aggregate sensor (or from each other) and connected remotely (e.g. via a Wi-Fi or Internet connection).

Reference is now made to FIG. 2 illustrating a generalized flow chart of training the consumption estimation system in accordance with certain examples of the presently disclosed subject matter. FIG. 2 will be described in conjunction with FIGS. 3A-3C. FIGS. 3A-3C illustrate configuration of the consumption estimation system 100 of FIG. 1 during various stages of training, in accordance with certain examples of the presently disclosed subject matter.

Prior to training, there is provided (201) an aggregate sensor operatively connected to the set of consumption devices. Referring to FIGS. 3A-3C, aggregate sensor 107 is operatively connected to CDs 101, 103, 105, 901 and 903.

Optionally, there can be provided (203) at least one context sensor related to one or more consumption devices and configured to provide context data informative of the environment of the respective consumption device(s). Referring to FIGS. 3A-3C, context sensor 123 is related to CDs 101-105, 901, and 903.

At each training stage, training further includes selecting (205) a subset of consumption devices from the set of consumption devices and operatively connecting an individual consumption sensor to each consumption device belonging to the selected subset of consumption devices.

Referring to FIG. 3A, for the first stage, a subset 161 of CDs 101 and 103 is selected from among the set of CDs 102. Sensor 121 is associated with CD 101 (e.g. via input interface 143) and sensor 122 is associated with CD 103 (e.g. via input interface 145). Referring to FIG. 3B, a new, different subset 163 of CDs 101 and 105 is selected from the set of CDs 102 for a second stage of training. Sensor 121 is associated with CD 101 (e.g. via input interface 143) and sensor 122 is associated with CD 105 (e.g. via input interface 145) for the second stage. Referring to FIG. 3C, another new, different subset 165 of CDs 103 and 105 is selected from the set of CDs 102 for the third stage of training. Sensor 121 is associated with CD 103 (e.g. via input interface 143) and sensor 122 is associated with CD 105 (e.g. via input interface 145) for the third stage.

The consumption sensors can be re-arranged at each next training stage in a manner in which each next subset of CDs includes at least one CD from a previous subset.

It will be appreciated that one or more of the same sensors used in one training stage can be reconnected to different CDs for the next training stage(s). Alternatively, some of the sensors can be dedicated to specific types of CDs (e.g. due to the compatibility of connectors, special requirements of consumption measurements for specific CDs, etc.), and can be connected when necessary.

It is noted that a number of CDs in a selected subset can differ during different training stages. It is also noted that, when appropriate, a number of CDs in a selected subset can be substantially (in one or more orders of magnitude) less than a number of CDs in a respective set of CDs.

Selection of a subset of CDs can be provided manually or automatically. Manual selection can be performed, for example, by a user. The user can connect the sensors to respective CDs or can select the CDs via a user interface (not shown) of the consumption estimation system, while the system will further enable connection in accordance with the user's configuration. Automatic selection can be performed, for example, by the processor 111 configured to enable reconnection of sensors to different CDs in the set of CDs. The selection can be performed according to certain rules stored in the memory 113 (e.g. based on if and/or which individual CDs have already been chosen to be part of a subset of CDs in a previous stage) or by random selection. Optionally, the selection mechanism can factor in the properties of already learned models.

At each training stage, upon selecting the subset of consumption devices and providing respective operative connection of individual consumption sensor to the selected consumption devices, consumption estimation block 119 obtains (209) measurements for the respective stage. Obtaining (209) measurements for the stage can include obtaining (211) measurements from the aggregate sensor, obtaining (213) CD-aware measurements from each consumption sensor, and optionally obtaining (215) measurements from the context sensor.

Obtaining (211) aggregate measurements, obtaining (213) CD-aware consumption measurements, and optionally obtaining (215) context measurements can occur substantially simultaneously and can include overlapping observation periods.

The obtained measured values can be associated with respective time stamps.

Referring to FIG. 3A, during the first training stage, aggregated measurements are obtained from aggregate sensor 107, CD-aware consumption measurements are obtained from sensor 121 and sensor 122, and context measurements are optionally obtained from context sensor 123. Referring to FIG. 3B, for the second stage measurements are obtained from sensor 121, sensor 122, aggregate sensor 107, and optionally context sensor 123.

During each training stage the consumption estimation block 119 further generates (217) an intermediate model indicative of the consumption relationships between the consumption devices based on the obtained measurements for the respective stage.

Referring to FIG. 3A, intermediate model (I) 115 is generated for the first stage based on the respectively obtained measurements. Intermediate model (I) 115 is generated using processor 111 of consumption estimation block 109 (e.g. using training module 400). Intermediate model (I) 115 is then stored in memory 113. Intermediate model (I) 115 is indicative of a probability of observations of aggregate sensor 107 given observations of the particular subset 161 of CDs from the first stage. Referring to FIG. 3B, intermediate model (II) 117 is generated based on the measurements obtained (209) for the second stage. Intermediate model (II) 117 is generated using processor 111 of consumption estimation block 109 (e.g. using training module 400). Intermediate model (II) 117 is then stored in memory 113. Referring to FIG. 3C, intermediate model (III) 119 is generated based on measurements obtained by sensors 121 and 122 on a subset 165 of CDs 103 and 105 for the third stage. Intermediate model (III) 119 is optionally generated using context measurements from context sensor 123. Intermediate model (III) 119 is generated using processor 111 of consumption estimation block 109 (e.g. using training module 400). Intermediate model (III) 119 is then stored in memory 113.

The following is an example of primary logic that can be used while executing the training phase. The following primary logic can be implemented for generating intermediate models:
Sl is a set of consumption sensors
   |Sl|≧1
D is a subset of consumption devices of interest
D={D₁, . . . , Dₙ}
T is a timespan
(Slᵢ, Dᵢ)εDEP_{T} denotes that sensor Slᵢ measures the consumption of Dᵢ in the stage DEP_{T} during timespan T
m(s,t) is the measurement of sensor s at timestamp t
sens(d,t) is the sensor connected to device d at timestamp t
For each dₓεD|∃(s,dₓ)εDEP_{T} and for each tεT:
   1. Learn model mod for determining mₓ
mₓ=P(m(sens(dₓ,t))|{m(sens(d_{y},t)|d_{y}≠dₓ}, {m(s,t)|sεSc}, m(Sa,t))
   mₓ is the conditional probability of a load value for dₓ given the other available sensor information
   Sc is a set of context sensors
   Sa is an aggregate load sensor
   2. Add the model mod to the set of learned models M
Create stage DEP_{T+1} by rearranging sensors in Sl
Repeat until a termination criterion is met (e.g. all devices in D are covered in at least one stage)

Upon generating an intermediate model corresponding to the respective stage, the consumption estimation block 119 checks (219) whether sufficient stage combinations have been captured. Sufficient stage combinations can be determined by one or more pre-defined criteria. The criteria can be optimized to find a balance between the quality of the results and the cost/effort required to obtain the results. Optionally, determining the criteria may be performed before checking 219. One example of a criterion can be the desired amount of stages and/or subsets for the given set of CDs. For example, sufficient stage combination can be captured when each known consumption device has been included during the training in at least one subset.

The following is an example of primary logic that can be used while executing the training phase. The following primary logic can be implemented for determining the termination criteria:
D is the set of all consumption devices d of interest
S is the set of consumption sensors s (e.g. smart Plugs/meters)
E is the set of available context sensors e (e.g. presence detectors/sensors)
M is the set of measurement combinations
M={mεPowerset(D)∥m|=|S|}
For optimal coverage:
Take measurements and generate a model for each mεM by building a measurement set MS=m∪E, where a sensor sεS is deployed at each device dεm.
For minimal coverage:
Find a graph G=(M′⊂M, V⊂M′×M′), such that:
   ∀(a,b)εV, |a∩b|=1
   G is a connected graph
   ∀ dεD: ∃ mεM′ such that dεm
         |M′| is minimal under the above conditions
G might be found e.g. through testing all 2̂|M| variants of building M′
Take measurements and generate a model for each m with mεM′ by building a measurement set MS=m∪E, where a sensor sεS is deployed at each device dεm.

Alternative viable measurement strategies may compromise between the optimal and the minimal coverage to make a tradeoff between the expected quality of the result and the effort of taking measurements.

If sufficient stage combinations have not been captured, then the consumption estimation block 119 continues training and repeats operations 205-219.

Typically, the arrangement of context sensor 123 is static throughout the process, and context sensor 123 remains in substantially the same position during the different stages of the training phase, but this is not necessarily so.

When sufficient stage combinations have been captured, then the consumption estimation block 119 generates (221) an operational model based on the intermediate models generated from each separate stage. Referring to FIG. 3C, operational model 131 is generated from intermediate models (I), (II) and (III) 115, 117 and 119. Operational model 131 is generated using processor 111 of consumption estimation block 109 (e.g. using training module 400). Operational model 131 is then stored in memory 113.

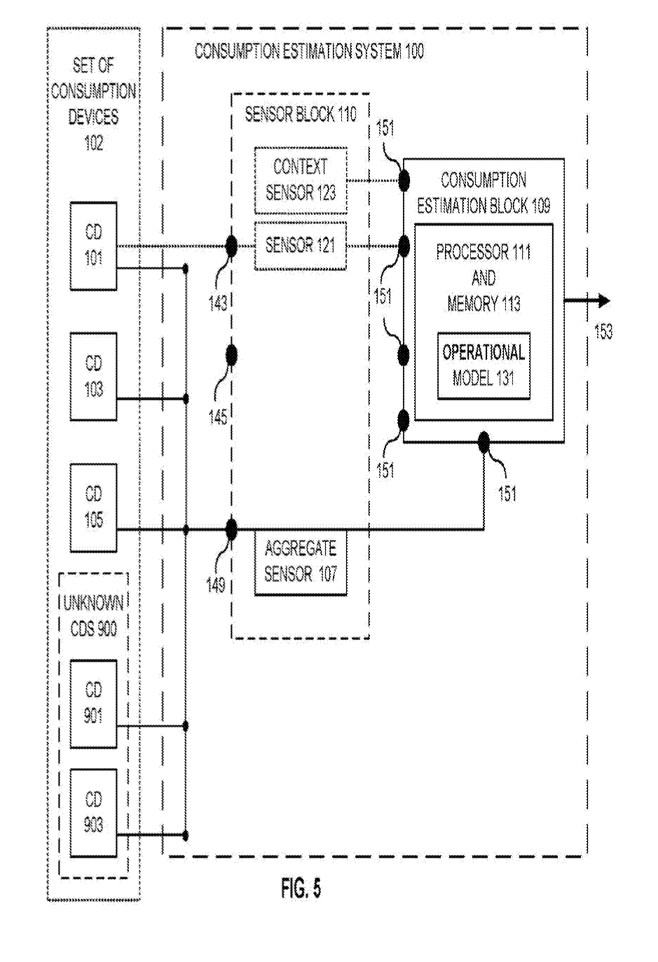

Reference is now made to FIG. 4 illustrating a generalized flow chart of operating the consumption estimation system in accordance with certain examples of the presently disclosed subject matter. FIG. 4 will be described in conjunction with FIG. 5, illustrating a configuration of the consumption estimation system during the operational phase.

Prior to operating there is provided (301) an aggregate sensor operatively connected to the set of consumption devices. Referring to FIG. 5, aggregate sensor 107 is operatively connected to CDs 101, 103, 105, 901 and 903.

Optionally, prior to operating there is provided (303) at least one consumption sensor associated with at least one consumption device from the plurality of known consumption devices from a subset of CDs used in the training phase. This optional sensor can be arranged in substantially the same way as is it was during at least one of the training stages. If a sensor was used to measure a plurality of CDs during training, then it can also be used for the same plurality of CDs during operation. Referring to FIG. 5, sensor 121 is optionally associated with CD 101.

Optionally, prior to operating there is provided (305) at least one context sensor related to at least one consumption device and configured to provide context data informative of the environment of the respective consumption device(s). Typically, during operation, the context sensors remain in substantially the same position that they were in during the training phase, but this is not necessarily so. Referring to FIG. 5, context sensor 123 is optionally related to CDs 101-105, 901, and 903.

Prior to operating there is also provided (307) an operational model of the consumption relationships between the consumption devices. Referring to FIG. 5, operational model 131 is provided.

Upon the setup (301-307) detailed above, the consumption estimation system can obtain (309) operational measurements. Obtaining (309) operational measurements can include obtaining (311) operational measurements from the aggregate sensor, optionally obtaining (313) operational measurements from the at least one consumption sensor, and optionally obtaining (315) operational measurements from the context sensor.

Obtaining (311) operational aggregate measurements, optionally obtaining (313) operational CD-aware consumption measurements, and optionally obtaining (315) operational context measurements can occur substantially simultaneously and can include overlapping observation periods.

The obtained measured values can be associated with respective time stamps.

Referring to FIG. 5, operational aggregate measurements are obtained from aggregate sensor 107, operational CD-aware consumption measurements are optionally obtained from sensor 121, and operational context measurements are optionally obtained from context sensor 123.

Operating further includes transforming (317) the measured operational values into estimated consumption values of one or more CDs from the set of CDs by applying the operational model of the consumption relationships between the consumption devices based on the obtained operational measurements. It is noted that the measured operational values can be transformed into estimated consumption values also for the unknown CDs 900.

Referring to FIG. 5, the measured operational values are transformed into estimated consumption values for one or more CDs (e.g. CDs 103, 105). The measured operational values are transformed into estimated consumption values by applying operational model 131 to the obtained (309) operational measurements. Operational model 131 is stored in memory 113. Operational model 131 is applied to the obtained operational measurements using processor 111 of consumption estimation block 109 (e.g. using estimation module 500). The results (resulting estimated consumption values) are then stored in memory 113. The results can also be transferred, transmitted, displayed or further processed accordingly. For example, the results can be output via output interface 153.

The following is an example of primary logic that can be used while executing the operational phase. The following primary logic can be implemented for calculating disaggregated consumption values:

$$\begin{matrix}arg max \\ m ( {d}_{1} , t ) , … , m ( {d}_{n ,} t )\end{matrix} {⋃}_{{mod}_{i} ∈ M} {mod}_{i}$$

Where U represents an aggregation of the likelihood of the models modᵢ given arguments m(d₁,t), . . . , m(dₙ,t).

The following is an example of primary logic that can be used for aggregating model likelihoods:

$$\begin{matrix}arg max \\ m ( {d}_{1} , t ) , … , m ( {d}_{n ,} t )\end{matrix} {\prod }_{{mod}_{i} ∈ M} {w}_{i} \cdot {mod}_{i}$$

wᵢ are weights

As an example, the weights can be assigned as a sum of sensors that are factored into a model, with each summand being divided by the number of models in which the corresponding sensor is considered.

The following is an example of primary logic that can be used while executing the training phase and the operational phase. The following primary logic can be implemented for specifying what needs to be calculated:
∀ m1ε(MS \E), m2εMS with |m1∩m2|=0,
P(values_of(m1)|values_of(m2)) can be determined for all dεm1

As an example, the data can be discretized and Naïve Bayes can be used for determining the dependent probabilities, representing P(values_of(m1)|values_of(m2)) as P(values_of(m1)|values_of(m1)∩values_of(m2)).
values_of: Powerset(D∪E)→Powerset((D∪E)×V)
values_of is a function that maps devices or context sensors to sensor observations V in the corresponding domain of measurements (e.g. load in watt for consumption of electrical energy).
vεV may be a single observation or a whole time-series of observations.
A multivariate Gaussian mixture model is one candidate model that has the needed properties.
OB→INFERRED maps observable values OB to likely corresponding values of not directly observable devices (INFERRED)
OB=values_of(ob)
ob⊂Powerset(D∪E) is the set of context sensors and sensor equipped devices that are available in the final setting (i.e. after training and during application time)

$$INFERRED := \begin{matrix}arg max \\ ( x , v )\end{matrix} ( P ( ( x , v ) ∈ values\_of ( \{ x \vert x ∈ UNOBSERVABLE \} ) \vert ob ) )$$

for a given observation ob and UNOBSERVABLE=D \{d|∃(d,v)εOB}

It is noted that the teachings of the presently disclosed subject matter are not bound by the flow charts illustrated in FIG. 2 and FIG. 4, and the illustrated operations can occur out of the illustrated order. For example, operations 221 can be commenced before completion of operations 205-219. It is also noted that whilst the flow chart is described with reference to elements of consumption estimation system 100, this is by no means binding, and some operations can be performed by elements other than those described herein.

It is to be understood that the invention is not limited in its application to the details set forth in the description contained herein or illustrated in the drawings. The invention is capable of other examples and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the examples of the invention as hereinbefore described without departing from its scope, defined in and by the appended claims.

1. A computerized method of estimating a consumption value of a consumption device from a set of consumption devices (CDs), the method comprising:
storing in a memory of a computer a model indicative of dependency between consumption relationships of CDs from the set of CDs, the model obtained by processing a plurality of intermediate models, each intermediate model obtained for a subset of at least one CD and indicative of dependency of consumption relationship between CDs from the respective subset and a value of aggregated consumption of all CDs from the set of CDs, wherein:
an intermediate model of a given subset is obtained by processing results of CD-aware consumption measurements having been taken from the given subset and substantially simultaneous measurements of intermediate aggregated consumption of all CDs from the set of CDs, wherein the CD-aware consumption measurements having been provided, for each given CD from the given subset of CDs, using at least one consumption sensor associated with the given CD during CD-aware consumption measurement;
and wherein subsets of CDs used in any two intermediate models from the plurality of intermediate models comprise at least one common CD;
measuring an operational aggregated consumption of the set of CDs, the operational aggregated consumption being measured using an aggregate sensor operatively connected to each CD from the set of CDs, and storing the results in the memory to yield an operational measured value of the operational aggregated consumption of all CDs from the set of CDs; and
transforming the operational measured value into estimated consumption values of one or more CDs, wherein transforming is provided by a processor operatively connected to the memory using the model stored in the memory.

2. The method of claim 1, further comprising, after storing and substantially simultaneous to measuring an operational aggregated consumption:
measuring an operational CD consumption of at least one CD, the operational CD consumption being measured using at least one consumption sensor associated with the given CD from the set of CDs, and storing the results in the memory to yield an operational measured value of the operational CD consumption of the given CD that overlaps at least partially with the operational measured value of the operational aggregated consumption of all CDs from the set of CDs; and
wherein transforming the operational measured value into estimated consumption values of one or more CDs is provided by a processor operatively connected to the memory and also using the operational measured value of the operational CD consumption of the given CD stored in the memory.

3. The method of claim 1, wherein the intermediate model of a given subset of at least one CD is obtained by also processing results of context measurements having been taken from the environment of at least one CD and substantially simultaneous to the intermediate measurements of aggregated consumption of all CDs from the set of CDs, wherein the context measurements having been provided using at least one context sensor related to the at least one CD.

4. The method of claim 3, wherein the CD-aware context measurements are indicative of at least one environmental parameter related to the at least one CD, the context measurements having been taken from the at least one context sensor disposed in the physical environment of the at least one CD.

5. The method of claim 3, further comprising, after storing and substantially simultaneous to measuring an operational aggregated consumption:
measuring an operational context measurement related to at least one CD, the operational context measurement being measured using at least one context sensor related to the given CD from the set of CDs, and storing the results in the memory to yield an operational measured value of the operational context measurements related to the given CD that overlaps at least partially with the operational measured value of the operational aggregated consumption of all CDs from the set of CDs; and
wherein transforming the operational measured value into estimated consumption values of one or more CDs is provided by a processor operatively connected to the memory and also using the operational measured value of the operational context measurements of the given CD stored in the memory.

6. The method of claim 1, wherein the set of CDs includes at least one unknown CD that is not included in any of the subsets, and transforming includes transforming the operational measured value into estimated consumption values of one or more unknown CDs, wherein transforming is provided by a processor operatively connected to the memory using the model stored in the memory.

7. The method of claim 1, wherein the model is obtained by processing a plurality of intermediate models, wherein each intermediate model is obtained by processing results of intermediate measurements of an aggregated consumption of all CDs from the set of CDs, and wherein the set of CDs includes at least one unknown CD that is not included in any of the subsets.

8. A consumption estimation block configured to estimate a consumption value of a consumption device from a set of consumption devices (CDs), the consumption estimation block comprising:
a processor and a memory, the consumption estimation block being operatively connectable to an aggregate sensor operatively connected to each CD from the set of CDs;
wherein the memory is configured to store a model, the model indicative of dependency between consumption relationships of CDs from the set of CDs, the model obtained by processing a plurality of intermediate models, each intermediate model obtained for a subset of at least one CD and indicative of dependency of consumption relationship between CDs from the respective subset and a value of aggregated consumption of all CDs from the set of CDs, wherein:
an intermediate model of a given subset is obtained by processing results of CD-aware consumption measurements having been taken from the given subset and substantially simultaneous measurements of intermediate aggregated consumption of all CDs from the set of CDs, wherein the CD-aware consumption measurements having been provided, for each given CD from the given subset of CDs, using at least one consumption sensor associated with the given CD during CD-aware consumption measurement; and
wherein subsets of CDs used in any two intermediate models from the plurality of intermediate models comprise at least one common CD;
wherein the memory is further configured to store an operational measured value of the operational aggregated consumption of all CDs from the set of CDs, the operational measured value having been yielded from an operational aggregated consumption of the set of CDs, the operational aggregated consumption having been provided using the aggregate sensor; and
wherein the processor is operatively connected to the memory and configured to transform the operational measured value into estimated consumption values of one or more CDs.

9. The consumption estimation block of claim 8,
wherein at least one consumption sensor is associated with a given CD from the set of CDs, the consumption sensor is configured to measure an operational CD consumption of at least one CD, and wherein the memory is configured to store the results to yield an operational measured value of the operational CD consumption of the given CD that overlaps at least partially with the operational measured value of the operational aggregated consumption of all CDs from the set of CDs; and
wherein the processor is configured to transform the operational measured value into estimated consumption values of one or more CDs also using the operational measured value of the operational CD consumption of the given CD stored in the memory.

10. The consumption estimation block of claim 8, wherein at least one context sensor is related to the at least one CD, the context sensor is configured to measure context measurements related to at least one CD, and the intermediate model of a given subset of at least one CD is obtained by also processing results of the context measurements related to the at least one CD that are substantially simultaneous to the intermediate measurements of aggregated consumption of all CDs from the set of CDs.

11. The consumption estimation block of claim 10, wherein the context measurements are indicative of at least one environmental parameter related to the at least one CD, and the at least one context sensor is disposed in the physical environment of the at least one CD.

12. The consumption estimation block of claim 10,
wherein the context sensor is configured to measure an operational context measurement related to at least one CD, and the memory is configured to store the results to yield an operational measured value of the operational context measurements related to the given CD that overlaps at least partially with the operational measured value of the operational aggregated consumption of all CDs from the set of CDs; and
wherein the processor is configured to transform the operational measured value into estimated consumption values of one or more CDs also using the operational measured value of the operational context measurements of the given CD stored in the memory.

13. The consumption estimation block of claim 8, wherein the set of CDs includes at least one unknown CD that is not included in any of the subsets, and the processor is configured to transform the operational measured value into estimated consumption values of one or more unknown CDs.

14. The consumption estimation block of claim 8, wherein the model is obtained by processing a plurality of intermediate models, wherein each intermediate model is obtained by processing results of intermediate measurements of an aggregated consumption of all CDs from the set of CDs, and wherein the set of CDs includes at least one unknown CD that is not included in any of the subsets.

15. A computerized method of generating a model usable for estimating a consumption value of a consumption device from a set of consumption devices (CDs), the method comprising:
upon obtaining a plurality of intermediate models indicative of consumption relationship between a subset of CDs, wherein:
an intermediate model of a given subset of at least one CD is obtained by processing results of CD-aware consumption measurements having been taken from the given subset and substantially simultaneous measurements of intermediate aggregated consumption of all CDs from the set of CDs, wherein the CD-aware consumption measurements having been provided, for each given CD from the given subset of CDs, using at least one consumption sensor associated with the given CD;
each intermediate model comprises at least one CD-aware consumption measurement provided by a CD that is included in at least one other subset;
processing the plurality of intermediate models to obtain a model indicative of dependency between consumption relationships of CDs from the set of CDs and storing the model in a memory of a computer;
wherein the model is usable for transforming an operational measured value of the operational aggregated consumption of all CDs from the set of CDs into estimated consumption values of one or more CDs; and
wherein transforming is provided by a processor operatively connected to the memory using the model stored in the memory upon obtaining an operational aggregated consumption of the set of CDs, the operational aggregated consumption being measured using an aggregate sensor operatively connected to each CD from the set of CDs, and storing the results in the memory to yield an operational measured value.

16. The method of claim 15, wherein transforming the operational measured value into estimated consumption values of one or more CDs is provided by a processor operatively connected to the memory and also using an operational measured value of CD consumption of the given CD stored in the memory.

17. The method of claim 15, wherein the intermediate model of a given subset of at least one CD is obtained by also processing results of context measurements having been taken from the environment of at least one CD and substantially simultaneous to the intermediate measurements of aggregated consumption of all CDs from the set of CDs, wherein the context measurements having been provided using at least one context sensor related to the at least one CD.

18. The method of claim 17, wherein the CD-aware context measurements are indicative of at least one environmental parameter related to the at least one CD, the context measurements having been taken from the at least one context sensor disposed in the physical environment of the at least one CD.

19. The method of claim 17, wherein transforming the operational measured value into estimated consumption values of one or more CDs is provided by a processor operatively connected to the memory and also using an operational measured value of the operational context measurements of the given CD stored in the memory.

20. The method of claim 15, wherein the set of CDs includes at least one unknown CD that is not included in any of the subsets, and transforming includes transforming the operational measured value into estimated consumption values of one or more unknown CDs, wherein transforming is provided by a processor operatively connected to the memory using the model stored in the memory.

21. The method of claim 15, wherein the model is obtained by processing a plurality of intermediate models, wherein each intermediate model is obtained by processing results of intermediate measurements of an aggregated consumption of all CDs from the set of CDs, and wherein the set of CDs includes at least one unknown CD that is not included in any of the subsets.
